(19) United States
(12) Patent Application Publication
(10) Pub. No.: US 2016/0039620 A1
(43) Pub. Date: Feb. 11, 2016

(54) Unloading a Cylindrical Body from a Pallet

(71) Applicant: Muzeen & Blythe Ltd., Winnipeg (CA)

(72) Inventor: Jacob A. Unrau, Winnipeg (CA)

(21) Appl. No.: 14/454,068

(22) Filed: Aug. 7, 2014

(51) Int. Cl. B65G 65/00; B65G 69/00

(52) U.S. Cl. CPC B65G 65/00; B65G 69/00

(57) ABSTRACT

A large cylindrical body such as a paper roll carried on a pallet is transferred to a transfer conveyor by placing the pallet on a platform carried on a platform support recessed in the floor movable to a lowered position in which the top surface of the pallet is level with the floor. A roll pusher with two rollers on a pusher head is moved out of an under floor receptacle across the top surface of the pallet so that the cylindrical body rolls off the pallet to a locating system at the transfer conveyor on one side of the platform. A pallet pusher abutment is moved across the platform in a slot to push the pallet along an edge guide at right angles to the rolling direction off the platform on to the floor.

This invention relates to a system for transportation of large heavy cylindrical objects such as paper rolls, for example for transportation of the rolls into a paper handling machine, and relates particularly to an apparatus for the transfer of a cylindrical body from a transportation pallet.

### BACKGROUND OF THE INVENTION

A system for handling paper rolls is shown in U.S. Pat. No. 5,213,467 (Harms) assigned to the present applicant and issued May 25 1993 which comprises an elongate channel member which is laid into the floor so that upper edges of the channel are substantially flush with the floor surface presenting an open top of the channel at the floor surface. In the floor channel is mounted a beam which provides longitudinal roller surfaces for receiving the rollers of a carriage. The carriage has a substantially horizontal upper surface for receiving the roll and a pair of depending sides which extend into the channel and carry the rollers which run along the roller surfaces of the beam. The carriage is moved longitudinally of the channel by a flexible elongate drive member such that chain or cable which is wrapped around guide pulleys and can be driven by an air motor located at one end of the channel. One part of the cable or chain is attached to the carriage so that the chain or cable moves along the channel the carriage is pulled with the roll on top of the carriage from one position to another.

Generally the horizontal surface of the carriage includes a shallow V-shaped groove with the apex of the V extending longitudinally of the channel so that the roll can be pushed manually or by machine onto the horizontal surface to be received within the V-shaped groove for movement longitudinally of the axis of the roll.

In the above patent, there is provided therefore a transport system for a large cylindrical body such as a roll of paper comprising an elongate channel member mounted in a floor surface, the channel member having parallel upper side edges positioned at a height substantially flush with the floor surface.

An elongate beam is mounted in the channel member and extends at least partly therealong. A carriage having an upper surface shaped for receiving and locating the roll thereon for transportation of the roll includes a plurality of rollers mounted on the carriage and shaped to run along the beam to move the carriage along the beam.

An elongate flexible drive element is positioned in the channel member and coupled to the carriage and is driven longitudinally of the channel member for transporting the carriage.

In the key feature of the above patent the beam is mounted in the channel member for movement vertically therein from a raised position, in which the upper surface of the carriage is located at a height to hold the body above the upper side edges for longitudinal movement of the body with the carriage, to a lowered position in which the carriage is displaced below the upper side edges.

This arrangement has been advantageous in the industry but another problem has remained unsolved. The cylindrical rolls, which are very heavy and can weigh as much as 8000 LBS, are supplied typically on a pallet which has a V-shaped groove in is upper surface to locate the cylindrical surface of the roll on the top surface of the pallet with the axis of the roll parallel to the top surface of the pallet. Such pallets are designed to be lifted and carried by fork lift in conventional manner. However in order to transfer the roll from the pallet to the above carriage for movement along the channel or track in which the carriage is located, it is typically necessary to employ an overhead crane to lift the roll off the pallet and to move it from the location of the pallet to the carriage. It is then necessary to move the pallet away to allow a further pallet to be moved into place thus requiring operators to coordinate and to carry out operation of the fork lift and the crane.

### SUMMARY OF THE INVENTION

It is one object of the present invention, therefore, to provide an improved transportation apparatus for cylindrical bodies such as paper rolls which can allow simpler transfer of the roll from its transportation pallet.

According to the invention there is provided a transport apparatus for a large cylindrical body carried on a transportation pallet where the pallet has a bottom surface for resting on a floor, an upper surface for locating the cylindrical body with an axis of the cylindrical body parallel to and transverse to the upper surface of the pallet, and a receptacle at a side of the pallet for a lifting system by which the pallet can be carried, the apparatus comprising:

a platform having a top surface onto which the bottom surface of the pallet can be received;

a platform support arranged to be recessed in the floor for moving the platform between a raised position in which the top surface is level with the floor so that the pallet can be moved into place on the platform and a lowered position in which the top surface is below the floor with the pallet thereon so that the top surface of the pallet is level with the floor;

a cylindrical body pusher movable across the top surface of the pallet, with the platform support in the lowered position in a direction at right angles to the axis of the cylindrical body to push the cylindrical body across the pallet and so that the cylindrical body rolls off the pallet to one side of the platform;

a locating system for the cylindrical body arranged on said one side of the platform to halt rolling of the cylindrical body at a required location and to confine the cylindrical body at the required location for transportation in a direction longitudinally of the axis of the cylindrical body;

and a pallet pusher movable across the top surface of the platform, with the platform support in the raised position, to push the pallet off the platform on to the floor.

Preferably the pallet pusher moves in a direction at right angles to that of the cylindrical body pusher where the pallet and platform are rectangular so that the loading of the pallets onto the platform can take place from one side and the unloaded pallets pushed off in a row in a direction at right angles to the loading direction.

Preferably the pallet pusher is carried on the platform so that it is moved up and down with the platform since this avoids the pusher being located in the floor. However the pusher can be an independent element.

Preferably the pallet pusher comprises an abutment member which traverses across the platform in a slot moved by an actuator extending across the platform.

Preferably the cylindrical body pusher is mounted in a receptacle at one side of the platform arranged to be recessed under the floor where the receptacle includes a cover panel arranged at floor level so that the pallet is transported to the platform on a forklift moving over the cover panel. However the pusher may be a part of or mounted on the platform.

Preferably the cylindrical body pusher comprises a pusher head and an actuator such as a hydraulic cylinder for moving the pusher head across the top surface of the pallet.

Preferably the actuator extends from a position under the floor to the pusher head at the cylindrical body and includes a first roller for rolling over the top surface of the pallet and a second roller for rolling against a peripheral surface of the cylindrical body as the head moves across the pallet surface and the roll rotates as it is moved forward.

Preferably the second roller is located forwardly and upwardly of the first roller. However the rollers may be aligned vertically.

In order to cause the head to move out of its under-floor receptacle preferably there is provided a ramp surface in the receptacle over which both the rollers roll to move the pusher head from a retracted position upwardly onto the top surface of the pallet.

Preferably the platform includes a stop wall at one edge against which an edge of the pallet abuts when moved into place by the forklift with the pallet pusher arranged to slide the pallet along the stop wall as it pushes the pallet away into a row of empty pallets.

Preferably the locating system comprises a first stop member in the form of a roller with its axis parallel to the axis of the roll on a remote side of the cylindrical body at the required location and a second stop member or roller on a near side of the required location. At least the second stop member and preferably both rollers are mounted in a container arranged to be located under the floor to allow the rollers to move to a retracted position under the floor to allow the cylindrical body to pass over the second stop member to the location.

Preferably there is provided a transportation device of the type shown in the above patent at the required location for transportation of the cylindrical body in a direction longitudinally of the axis of the cylindrical body.

Preferably the transportation device comprises an elongate channel member arranged to be mounted in the floor, the channel member having parallel upper side edges positioned at a height substantially flush with the floor, a carriage having an upper surface shaped for receiving and locating the cylindrical body thereon for transportation of the body therewith, a plurality of rollers mounted on the carriage and shaped to run along the channel member to move the carriage therealong.

Preferably the channel member includes a beam for transporting the carriage therealong, at least a portion of the beam being mounted in the channel member for movement vertically therein from a raised position, in which the upper surface of the carriage is located at a height to hold the body above the upper side edges for longitudinal movement of the body with the carriage, to a lowered position in which the carriage is displaced below the upper side edges.

### BRIEF DESCRIPTION OF THE DRAWINGS

One embodiment of the invention will now be described in conjunction with the accompanying drawings in which:

FIG. 1 is a vertical longitudinal cross-section taken along lines 1-1 of FIG. 2 of a system for transportation of heavy cylindrical objects such as paper rolls in accordance with the present invention;

FIG. 2 is a top plan view of the components of FIG. 1;

FIG. 3 is a cross-sectional of the components of FIG. 1 in a second position of the operation of the components;

FIG. 4 is a cross-sectional of the components of FIG. 1 in a third position of the operation of the components;

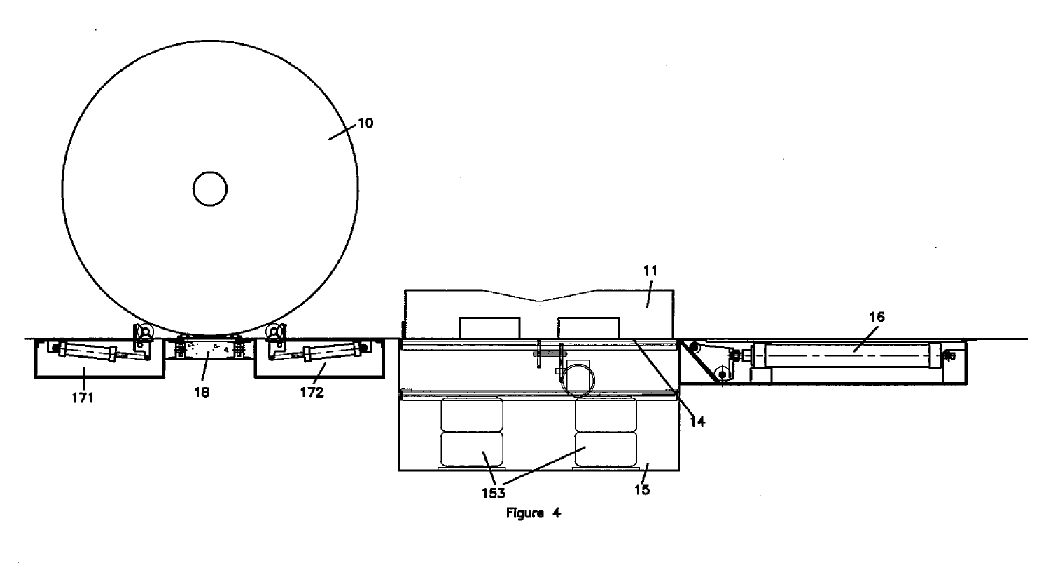

FIG. 5 is a vertical longitudinal cross-section taken along lines 5-5 of FIG. 2 of the system for transportation FIG. 1.

In the drawings like characters of reference indicate corresponding parts in the different figures.

### DETAILED DESCRIPTION

The apparatus for transporting a large cylindrical body such as a roll of paper 10 includes a transportation pallet 11 where the pallet has a bottom surface 111 for resting on a floor 12, an upper surface 112 for locating the cylindrical body with an axis 101 of the roll 10 parallel to and transverse to the upper surface of the pallet 11, and a receptacle 113, 114 at a side of the pallet 11 for a lifting system such as a fork lift 13 by which the pallet can be carried. The pallet has a V-shaped notch 115 in its upper surface to locate the roll against rolling off the upper surface.

The apparatus includes a platform 14 contained within a receptacle defining a platform support 15, a roll pushing assembly 16, a locating system 17, a transportation system 18 and a pallet pushing assembly 19.

The platform is a generally rectangular body with a top surface 140 onto which the bottom surface of the pallet can be received with the platform having side edges 141, a front edge 143 and a rear edge 142 dimensioned to receive the pallet contained within the area of the top surface. The platform contains suitable structural members to allow the load from the pallet and toll to be suitably supported.

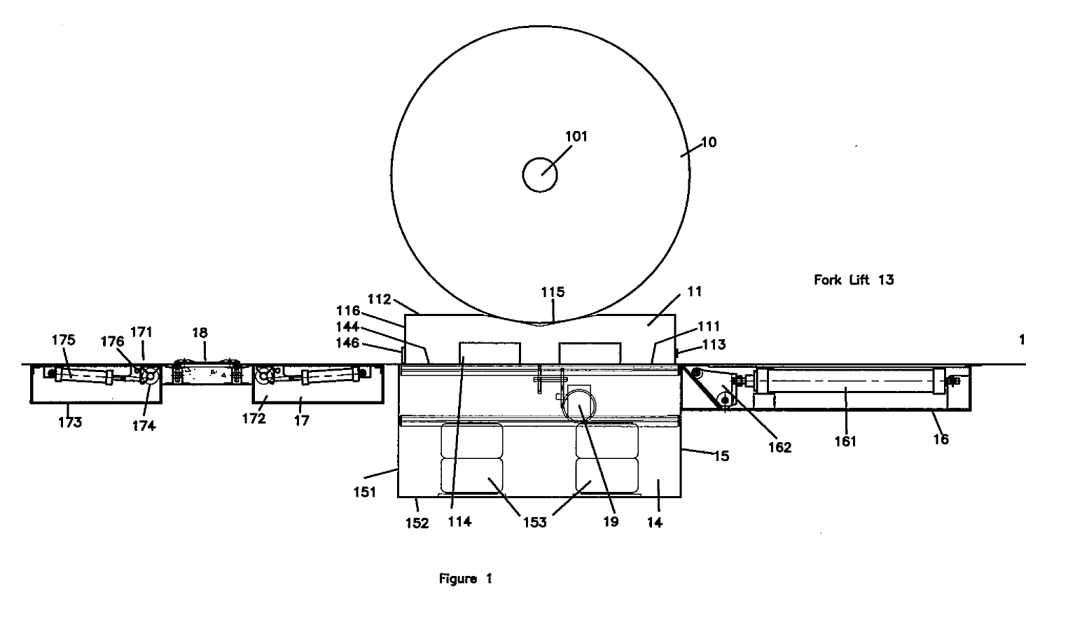

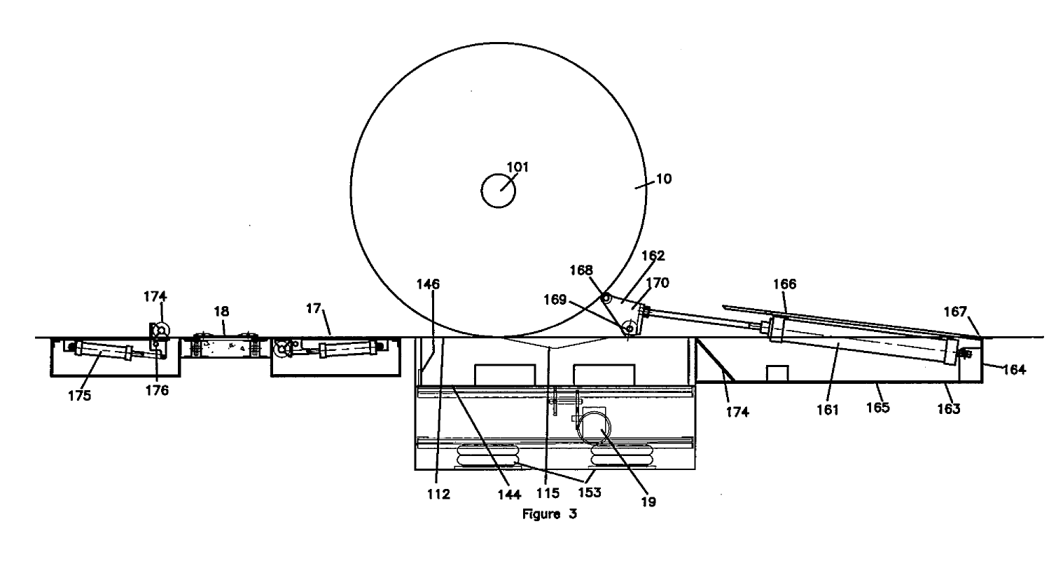

The platform support 15 forms a rectangular receptacle with side walls 151 and a base 152 shaped to match the shape of the platform 14 to receive the platform and allow it to be raised and lowered within the receptacle on a suitable lift system such as the gas I air bags 153 as illustrated. The receptacle 15 is arranged to be recessed in the floor 12 below floor level for moving the platform 14 from a raised position shown in FIG. 1 in which the top surface 144 is level with the floor 12 so that the pallet 11 can be moved into place on the platform 14 by the transport device 13. The platform can be lowered by the lift system 153 to a lowered position shown in FIG. 3 in which the top surface 144 is recessed below the floor 12 by a distance equal to the height of the pallet and with the pallet thereon so that the top surface 112 of the pallet is now level with the floor 12.

The platform 14 includes a stop wall 146 at the rear edge 143 against which an edge 116 of the pallet abuts when accurately loaded onto the platform. The stop wall moves up and down with the platform and acts merely to locate eh pallet to ensure that it does not hang up on the floor when the platform is lowered.

The roll pusher 16 comprises a cylinder 161 with a head 162 attached to a rod of the cylinder so as to be movable across the top surface 112 of the pallet, with the platform support in the lowered position as shown in FIG. 1. The head 162 as shown in FIG. 3 is movable in a direction at right angles to the axis 101 of the roll 10 to push the roll across the pallet 11 and so that the roll 10 rolls off the pallet 11 to the side of the platform at the locating system 17 and the transfer system 18.

The cylinder 161 is mounted in a receptacle 163 with side walls 164 and a base 165 arranged to be recessed under the floor 12. The receptacle 163 includes a cover panel 166 hinged at 167 and arranged at floor level so that the pallet is transported to the platform over the closed cover panel 166 lying in the floor level. However the cover panel can be lifted by deployment of the cylinder 161 to allow the head 162 and the rod to escape through an open end of the receptacle onto the top surface of the pallet.

The pusher head 162 includes a first roller 169 for rolling over the top surface of the pallet and a second roller 168 for rolling against a peripheral surface of the cylindrical body. The rollers 168 and 169 are carried on a holder 170 fixed to the end of the cylinder rod so that the second roller is located and held at a position forwardly and upwardly of the first roller. There is provided a ramp surface 179 at an angle matching that of or parallel to a line joining the centers to the rollers over which both the rollers roll as the cylinder is extended to move the pusher head from a retracted position lying within the receptacle 163 with the cylinder horizontal upwardly onto the top surface of the pallet. This upward movement caused by the sliding of the rollers up the ramp acts to open the cover 166 and cause the roller 169 to roll over the surface until the roller 168 reaches the roll 10 to push the roll from its receptacle 115 on the pallet 11.

The roll thus moves across the pallet onto the floor 12 toward the transfer carriage 18. As it reaches the carriage it is confined by the locating system 17 to halt rolling of the roll at the required location and to confine the roll at the required location for transportation on the carriage in a direction longitudinally of the axis 101 of the cylindrical body;

The locating system 17 comprises a first stop member 171 on a remote side of the carriage 18 at the required location and a second stop member 172 on a near side of the required location. Each of the second stop members is mounted in a container 173 arranged to be located under the floor 12 to allow the stop members to move to a retracted position under the floor to allow the roll to pass over the second stop member 172.

Each of the first and second stop members comprises a roller 174 actuated by a cylinder 175 which acts to tilt a roller support about an axis 176 parallel to an axis of the roller 174 to raise the roller above the floor surface as a stop as shown in FIG. 3. The stop member 171 is activated with cylinder 161 and 172 is controlled by a detector eye 20 in the receptacle 173 of the stop member 172 so as to time the lifting of the stop rollers 174 on 172 assembly to halt the rolling motion of the roll at the carriage 18.

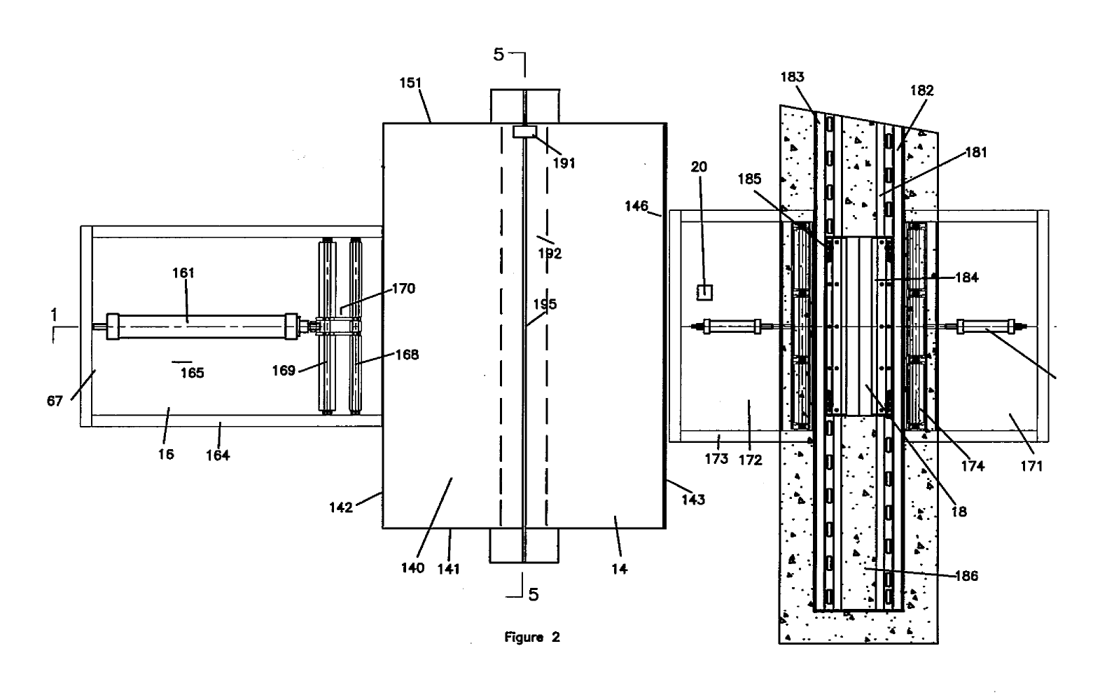

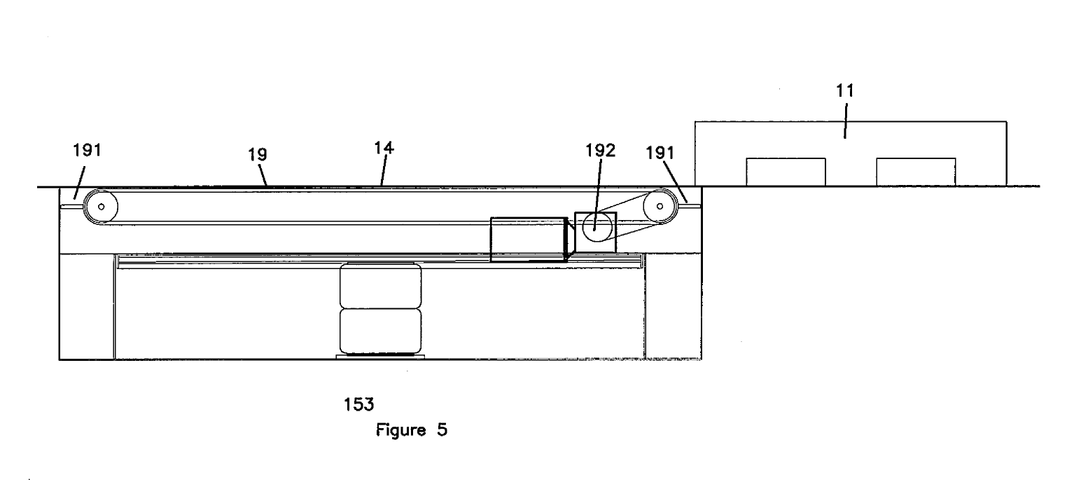

The pallet pusher for discarding an empty pallet is 19 is best shown in FIGS. 2 and 5 and comprises a movable abutment 191 carried on the platform and movable across a slot 195 in the top surface of the platform 14 and driven by a suitable drive mechanism such as a cylinder 192. Thus, with the platform support in the raised position shown in FIG. 5, the pusher abutment 191 acts to push the pallet off the platform on to the floor. The stop wall 146 at the rear edge 143 of the platform acts as a locating guide against which an edge 116 of the pallet slides with the pallet pusher along the stop wall in a direction at right angles to that of the roll pusher.

The transportation carriage 18 at the required location between the stop members 1 is arranged for transportation of the roll in a direction longitudinally of the axis of the cylindrical body and can be of the construction shown in the above prior patent.

Thus the transportation device 18 which can be a single carriage or a series of carriages one behind the other located in an elongate channel member 181 arranged to be mounted in the floor with the channel member having parallel upper side edges 181, 182 positioned at a height substantially flush with the floor 12. A carriage 184 has an upper surface shaped for receiving and locating the roll for transportation of the roll and a plurality of rollers 185 mounted on the carriage itself or in the track and shaped to run along the channel member 181 to move the carriage to an end use station.

The channel member 181 includes a beam 186 for transporting the carriage therealong, at least a portion of the beam being mounted in the channel member for movement vertically therein from a raised position, in which the upper surface of the carriage is located at a height to hold the body above the upper side edges for longitudinal movement of the body with the carriage, to a lowered position in which the carriage is displaced below the upper side edges for loading. This arrangement is shown in detail in the above referenced patent.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A transport apparatus for a large cylindrical body carried on a transportation pallet where the pallet has a bottom surface for resting on a floor, an upper surface for locating the cylindrical body with an axis of the cylindrical body parallel to and transverse to the upper surface of the pallet, and a receptacle at a side of the pallet for a lifting system by which the pallet can be carried, the apparatus comprising:
a platform having a top surface onto which the bottom surface of the pallet can be received;
a platform support arranged to be recessed in the floor for moving the platform between a raised position in which the top surface is level with the floor so that the pallet can be moved into place on the platform and a lowered position in which the top surface is below the floor with the pallet thereon so that the top surface of the pallet is level with the floor;
a cylindrical body pusher movable across the top surface of the pallet, with the platform support in the lowered position in a direction at right angles to the axis of the cylindrical body to push the cylindrical body across the pallet and so that the cylindrical body rolls off the pallet to one side of the platform;
a locating system for the cylindrical body arranged on said one side of the platform to halt rolling of the cylindrical body at a required location and to confine the cylindrical body at the required location for transportation in a direction longitudinally of the axis of the cylindrical body;
and a pallet pusher movable across the top surface of the platform, with the platform support in the raised position, to push the pallet off the platform on to the floor.

2. The transport apparatus according to claim 1 wherein the pallet pusher moves in a direction at right angles to that of the cylindrical body pusher.

3. The transport apparatus according to claim 1 wherein the pallet pusher is carried on the platform.

4. The transport apparatus according to claim 1 wherein the pallet pusher comprises an abutment member which traverses across the platform.

5. The transport apparatus according to claim 1 wherein the platform includes a slot across which the abutment member is moved by an actuator extending across the platform.

6. The transport apparatus according to claim 1 wherein the cylindrical body pusher is mounted in a receptacle arranged to be recessed under the floor and includes a cover panel arranged at floor level so that the pallet is transported to the platform over the cover panel.

7. The transport apparatus according to claim 1 wherein the cylindrical body pusher comprises a pusher head and an actuator for moving the pusher head across the top surface of the pallet.

8. The transport apparatus according to claim 7 wherein the actuator comprises a cylinder which extends from a position under the floor to the pusher head at the cylindrical body.

9. The transport apparatus according to claim 1 wherein the pusher head includes a first roller for rolling over the top surface of the pallet and a second roller for rolling against a peripheral surface of the cylindrical body.

10. The transport apparatus according to claim 1 wherein the second roller is located forwardly and upwardly of the first roller.

11. The transport apparatus according to claim 1 wherein there is provided a ramp surface over which both the rollers roll to move the pusher head from a retracted position upwardly onto the top surface of the pallet.

12. The transport apparatus according to claim 1 wherein the platform includes a stop wall at one edge against which an edge of the pallet abuts with the pallet pusher arranged to slide the pallet along the stop wall.

13. The transport apparatus according to claim 1 wherein the locating system comprises a first stop member on a remote side of the cylindrical body at the required location and a second stop member on a near side of the required location, at least the second stop member being mounted in a container arranged to be located under the floor to allow the second stop member to move to a retracted position under the floor to allow the cylindrical body to pass over the second stop member.

14. The transport apparatus according to claim 13 wherein the first stop member is mounted in a container arranged to be located under the floor to allow the first stop member to move to a retracted position under the floor.

15. The transport apparatus according to claim 13 wherein the first and second stop members each comprise a roller.

16. The transport apparatus according to claim 1 further comprising a transportation device at the required location for transportation of the cylindrical body in a direction longitudinally of the axis of the cylindrical body.

17. The transport apparatus according to claim 1 wherein the transportation device comprises an elongate channel member arranged to be mounted in the floor, the channel member having parallel upper side edges positioned at a height substantially flush with the floor, a carriage having an upper surface shaped for receiving and locating the cylindrical body thereon for transportation of the body therewith, a plurality of rollers mounted on the carriage and shaped to run along the channel member to move the carriage therealong.
